(19) United States
(12) Patent Application Publication
(10) Pub. No.: US 2022/0117212 A1
(43) Pub. Date: Apr. 21, 2022

(54) AGRICULTURAL SPRAYER CONTROL SYSTEM AND METHOD

(71) Applicant: Rovic International (Pty) Ltd, Cape Town (ZA)

(72) Inventor: Marthinus Christoffel David Ras, Cape Town (ZA)

(21) Appl. No.: 17/075,433

(22) Filed: Oct. 20, 2020

(51) Int. Cl. A01M 7/00; B05B 12/12; B05B 12/08; G05B 19/416; A01C 23/04; A01C 23/00

(52) U.S. Cl. CPC A01M 7/0089; B05B 12/126; B05B 12/085; G05B 2219/45013; A01C 23/047; A01M 7/0025; A01C 23/007; G05B 19/416

(57) ABSTRACT

Methods and systems for administering agrochemicals with an agricultural sprayer are provided. In a method a ground speed of the sprayer is measured. A current volumetric air flow produced by a fan of the sprayer is determined and compared with a required volumetric airflow. Settings of the fan (such as rotational speed and blade pitch settings) are adjusted if the current and required volumetric air flows differ The required volumetric air flow of the fan is determined using the measured ground speed, a configured plant height and width and sprayer air volume delivery curves at different fan settings.

### FIELD OF THE INVENTION

This invention relates to agricultural sprayers used for the application of agrochemicals, for example insecticides, fungicides, growth regulators and foliar feeds to orchards. More specifically, it relates to control systems for controlling such sprayers.

### BACKGROUND TO THE INVENTION

The efficient application of agrochemicals to crops such as nuts and pome, stone, citrus, and subtropical fruit is one of the key elements in assuring a quality crop in commercially acceptable quantities.

A known type of agricultural sprayer is drawn on a trailer through orchard rows, generally by a tractor, having a reservoir in which a liquid mixture of the particular agrochemical to be dispensed and water as a carrier medium may be stored. Mounted behind the reservoir is a fan housed within a cowl which directs air onto a deflector that in turn directs the air generally radially outwardly. Such deflectors have a somewhat conical or domed shape. Atomizing sprayer nozzles are provided that are angularly arranged about the cowl. The sprayer nozzles are in fluid communication with the reservoir and the liquid mixture is expelled under pressure through the nozzles into the air stream. Between approximately the 4 o'clock and 8 o'clock positions, no nozzles are provided since it would be directed onto the ground or the trailer chassis and is therefore referred to as the “dead sector”. The radially outward flow of air aids to carry the atomized liquid onto the target, typically fruit trees.

With reference to pome and stone fruit, the shape and structure of these fruit trees have changed dramatically over the years. Previously the trees had an open vase shape and were typically planted in rows having between 5.5 meter (m) and 7 m row widths and typically reaching heights of about 6 m and widths (i.e. the transverse dimension of the foliage) of more than 5 m. This resulted in about 230 to 250 trees planted per hectare.

Historically, these large structures were sprayed with conventional low-profile axial fan sprayers, delivering in excess of 50,000 m³/hour air volume at outlet speeds of about 35 m/second. Such machines may require more than 35 kilowatt (kW) to drive its fan and its high-pressure pump which are in concert responsible for the atomization of the sprayed liquid and for the calibration to the required distributed volume, which could often exceed 3000 liters per hectare. These sprayers will hereafter be referred to as conventional sprayers.

In contrast to this, the modern-day orchard structure has seen considerable changes both in shape, size and density of planting. A central leader system is used with row widths between 3.5 m and 4.5 m. Tree heights are typically limited to 4 m and tree widths between 0.8 m and 2 m and having a generally conical shape. These orchards typically have in excess of 1000 trees planted per hectare, and the required agrochemical application volumes have reduced to between 500 and 750 liters per hectare. This modern-day orchard practice is referred to as high density planting.

The change in orchard structures have brought about a number of advantages, especially with reference to high density planting. The tree structures having a generally conical shape allows more sunlight reaching the foliage and, in turn, results in more vigorous growth. This allows some trees to reach full production potential within five years of planting. Historical planting typically required up to 10 years to reach full production potential. The increased amount of foliage receiving sunlight also results in superior crop production volumes and has been shown to yield up to 50% greater production volumes compared to historical orchards. The tree shapes and orchard structures also facilitate enhanced harvesting practices.

It may be expected that the application of agrochemicals may be more efficient with the modern tree structure being less complex. It may furthermore be expected to have better utilization of the chemicals and less environmental contamination. However, the use of conventional sprayers in the modern orchard structure has had some detrimental results.

The excessive air momentum required by the conventional sprayers in order for the agrochemicals to reach the extremities of the trees may result in the agrochemicals in areas proximate the sprayer to be blown off the target. This has been evident in that after application of anti-fungal chemicals with conventional sprayers, infection developed on the outside of fruits having been approximately 0.5 m from the sprayer at the time of application. Decreasing the air momentum generated by the sprayer to prevent this will result in the sprayer being unable to reach the uppermost areas of the trees, which would in turn make such areas susceptible to infection, infestation or deprived of nutrients as the case may be.

The applicant's own South African patent application number 2017/02417 addresses these issues by providing a tower-type sprayer having a generally upwardly orientated fan housed within a cowl. The sprayer operatively blows air in a generally axial direction onto a deflector adjacent thereto that is configured to direct the air generally radially outwardly. A conduit extends generally upwardly from the deflector such that air deflected radially upwardly from the deflector is channeled through the conduit and out through at least one outlet. A passage is provided having an inlet through the deflector and an outlet which operatively directs air into the conduit generally parallel to the air from the deflector. The conduit may be bifurcate along its length to provide two outlets extending along the lateral sides of the conduit. Each of the outlets may have airfoils arranged to operatively direct air flowing out of the outlets and spray nozzles to be positioned along the outlets. The outlets may further have an adjustable overhang provided at its uppermost area to allow configuration of the vertical reach of the airflow out of the outlets in use.

Through experimentation the applicant has developed an equation for effective application of agrochemicals in which the air volume that is required from the sprayer is a product of the ground speed of the vehicle drawing the sprayer, the height of the trees to be sprayed and also the required penetration depth into the trees (i.e. the tree width). The vector sum of sprayer outlet air speed vector and the ground speed vector give the resultant vector direction and locus distance to the target. Therefore, the greater the ground speed vector, the longer the locus distance to the target with the result that more air velocity is required at the sprayer outlets to reach the center of the tree at an optimal air speed profile.

The height and width of the trees, although variable from orchard to orchard, maintain a constant average for a particular orchard. The only operator controllable, dynamic variables during operation are the ground speed of the sprayer and the air volume produced by the fan.

However, in known sprayers, the ground speed and the air volume produced by the fan may be linked through the mechanical operation of the sprayer, which makes it impossible to achieve equilibrium between the required air flow and the ground speed of the sprayer. This may be so because sprayers are generally powered by the power take-off (PTO) provided on a tractor. The mechanical power from the PTO is generally transferred to a gearbox on the sprayer which, in turn, drives the fan. Therefore, the speed of the fan is generally proportional to the rotational velocity of the PTO output shaft and the selected gear ratio on the sprayer. Since the gearbox is generally provided with fixed gear ratios (2 fixed gear ratios in one known sprayer), it may not be possible to obtain a required fan speed if a required gear ratio falls between the available ratios.

It may also not be possible to achieve a required ground speed whilst also maintaining the standardized PTO rotational speed, which is 540 revolutions per minute (rpm), since the PTO speed may be directly coupled to the engine of the tractor. The available tractor gear selections may not allow a required ground speed and a required PTO speed to be maintained simultaneously.

Also, a particular required ground speed may not be feasible depending on the terrain.

Furthermore, it is generally assumed that the PTO is operated at the standardized rotational speed of 540 rpm. However, due to operator error, the correct engine speed may not actually be maintained. Furthermore, the PTO speed gauge may be inaccurate.

All these factors therefore impede the balancing between the air flow and the ground speed of the sprayer which, in turn, may lead to sub-optimal spraying. The applicant believes there to be room for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method for administering agrochemicals with an agricultural sprayer, the method performed at a control system of the sprayer and comprising:
measuring a ground speed of the sprayer;
obtaining a current volumetric air flow produced by a fan of the sprayer;
determining a required volumetric air flow of the fan using the measured ground speed, a configured plant height and width and using sprayer air volume delivery curves at different fan settings; and
controlling the adjustment of a setting of the fan to obtain the required volumetric air flow if different from the current volumetric air flow.

Further features provide for the step of controlling the adjustment of a setting of the fan to obtain the required volumetric air flow to include the optimization of a balance between a required air volume produced by the sprayer, an actual sprayer ground speed, and plant height and width.

Further features provide for the step of measuring the ground speed to include obtaining ground speed data from a global satellite navigation system in communication with the control system; alternatively obtaining ground speed data by means of a Doppler-effect ground speed sensor; further alternatively by measuring a number of revolutions of a wheel of the sprayer over a time period and obtaining ground speed by using this measurement and a configured circumference of the wheel.

Further features provide for the method to include the step of measuring a current application rate of spray nozzles of the sprayer; determining a required application rate of the spray nozzles using the measured ground speed; and controlling the adjustment of a control valve associated with the spray nozzles to obtain the required application rate if different from the current rate.

Further features provide for the method to include the step of disabling the fan if the measured ground speed is below a minimum ground speed threshold; and the step of disabling the spray nozzles if the measured ground speed is below a minimum ground speed threshold.

Further features provide for the method to include the steps of receiving, as inputs, a plant height and a plant width; and configuring the control system with the received plant height and plant width.

In one embodiment, the fan may have an adjustable blade pitch and the step of controlling the adjustment of the setting may include controlling the adjustment of a pitch of the fan blades.

In another embodiment, the setting of the fan may be a rotational speed of the fan and the step of controlling the adjustment of the setting may include controlling the adjustment of a drive speed of a drive associated with the fan.

The drive associated with the fan may be a variable gear ratio transmission and the step of controlling the adjustment of the drive speed may include adjusting a gear ratio of the transmission to obtain the required rotational fan speed. The variable gear ratio transmission may be a hydrostatic drive in which case the ratio is adjusted by adjusting a swashplate of the hydrostatic drive, alternatively a continuously variable transmission (CVT) in which case the ratio is adjusted by adjusting a ratio of the CVT.

Further features provide for the sprayer to be powered by a power take-off (PTO); and for the sprayer to be adapted to be drawn by a tractor.

The drive associated with the fan may alternatively be an internal combustion engine with an electronically controllable throttle; or an electric motor controlled with a variable speed drive.

In accordance with another aspect of the invention there is provided a control system for an agricultural sprayer comprising:
a ground speed measuring component arranged to measure a ground speed of the sprayer;
a volumetric air flow obtaining component arranged to obtain a current volumetric air flow of a fan of the sprayer;
a configuration storage component arranged to store a configured plant height and width;
a required volumetric air flow obtaining component arranged to obtain a required volumetric air flow of the fan using measurements of the ground speed measuring component, the configured plant height and width, and air volume delivery curves at different fan settings; and
a fan setting adjusting component arranged to control the adjustment of a setting of the fan to obtain the required volumetric air flow if different from the current volumetric air flow.

Further features of this aspect provide for the ground speed measuring component to include a global satellite navigation component for obtaining ground speed measurements from a global satellite navigation module.

Alternative features provide for the ground speed measuring component to include a ground speed sensor component for obtaining ground speed measurements from a Doppler-effect ground speed sensor.

Further alternative features provide for the ground speed measuring component to include a wheel revolution component for measuring a number of revolutions of a wheel of the sprayer over a time period and obtaining ground speed by using this measurement and a circumference of the wheel stored in the configuration storage component.

Further features of this aspect provide for the control system to include an application rate measuring component for measuring a current application rate of spray nozzles of the sprayer; a required application rate determining component for determining a required application rate of the spray nozzles using the measured ground speed; and a control valve adjusting component for controlling the adjustment of a control valve associated with the spray nozzles to obtain the required application rate if different from the current rate.

Further features provide for the application rate measuring component to be in communication with a flow sensor adapted to detect the flow rate of a fluid in a conduit that feeds the nozzles.

Further features provide for the fan setting adjusting component to be adapted to disable the fan if the measured ground speed is below a minimum ground speed threshold stored in the configuration storage component; and for the control valve adjusting component to be adapted to disable the spray nozzles if the measured ground speed is below a minimum ground speed threshold stored in the configuration storage component.

Further features provide for the control system to include an input component for receiving configuration inputs; for the configuration inputs to include one or more of the group consisting of a plant height, a plant width, and a minimum ground speed threshold; and for the input component to be adapted to communicate the inputs to the configuration storage component for storage therein.

In one embodiment, the fan may have an adjustable blade pitch and the fan setting adjusting component may include a blade pitch setting component arranged to control the adjustment of a blade pitch setting of the fan.

In another embodiment the fan may have a drive associated therewith and the fan setting adjusting component may include a fan speed setting component arranged to control a speed setting of the drive to thereby control a rotational speed setting of the fan.

In accordance with a further aspect of the invention there is provided an agricultural sprayer having a control system, the control system comprising:
a ground speed measuring component arranged to measure a ground speed of the sprayer;
a volumetric air flow obtaining component arranged to obtain a current volumetric air flow of a fan of the sprayer;
a configuration storage component arranged to store a configured plant height and width;
a required volumetric air flow obtaining component arranged to obtain a required volumetric air flow of the fan using measurements of the ground speed measuring component, the configured plant height and width, and air volume delivery curves at different fan settings; and
a fan setting adjusting component arranged to control the adjustment of a setting of the fan to obtain the required volumetric air flow if different from the current volumetric air flow.

Embodiments of the invention will now be described, by way of example only, with reference to the accompanying drawings.

### BRIEF DESCRIPTION OF THE DRAWINGS

In the drawings:

FIG. 1 is a schematic representation of a system including a control system for an agricultural sprayer;

FIG. 2 is a flow diagram illustrating a method for administering agrochemicals in accordance with an aspect of the invention;

FIG. 3 is a block diagram showing functional modules of a control system in accordance with an aspect of the invention; and

FIG. 4 is a schematic representation illustrating an example of a computing device in which various aspects of the disclosure may be implemented.

### DETAILED DESCRIPTION WITH REFERENCE TO THE DRAWINGS

A method and a control system for administering agrochemicals with an agricultural sprayer are disclosed below. The method and control system find application with any agricultural sprayer that utilizes a fan to create an air flow. The air flow directs a mist created by spray nozzles of the sprayer toward an application target.

A volumetric air flow of a fan of the agricultural sprayer is controlled in order to optimize the delivery of the mist created by nozzles of the sprayer in accordance with delivery curves having ground speed, tree width and height as variables. A control system of the agricultural sprayer controls the volumetric air flow by adjusting a setting of the fan, which may increase or decrease the volumetric air flow of the fan as may be required. Examples of settings of the fan that may be adjusted to control the volumetric air flow produced thereby, is its rotational speed setting; and a pitch setting of the blades of the fan. A combination of these settings may also be utilized. Reasons for using a combination of settings may include enabling fine-tuning that may not be able with adjusting just one of the settings.

The fan may have an associated drive, which may be a variable gear ratio transmission such as a hydrostatic drive or a continuously variable transmission (CVT). The drive associated with the fan may also be an internal combustion engine with an electronically controllable throttle; or an electric motor controlled with a variable speed drive to name a few examples.

As mentioned above, the ground speed of the sprayer (among other variables) is used in determining the required volumetric air flow. The ground speed may be determined with a global positioning system (GPS); a Doppler-effect ground speed sensor; or by measuring a number of revolutions of a wheel of the sprayer over a time period and obtaining ground speed by using this measurement and a circumference of the wheel, for example.

The agricultural sprayer may be adapted to be drawn by a drawing vehicle, such as a tractor, or may be a self-propelled implement.

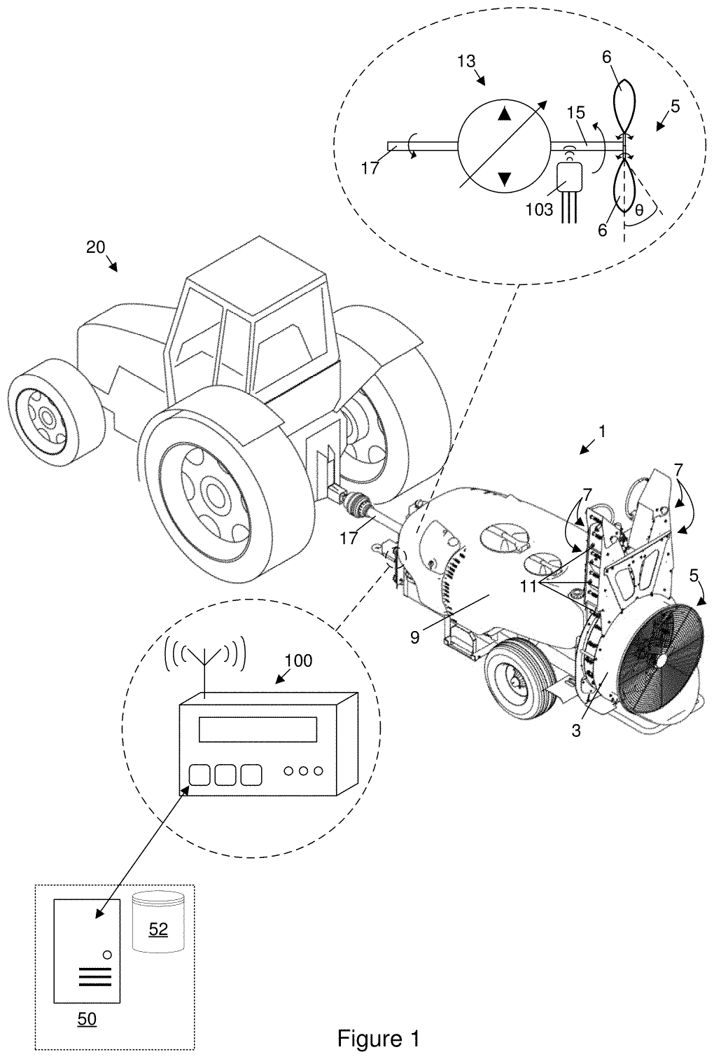

An exemplary embodiment of a sprayer (1) is shown in FIG. 1 that will be used for illustration purposes in the description below. The sprayer (1) includes a cowl (3) housing a fan (5). The fan (5) operatively creates an air flow that exits through air outlets (7) and causes the resulting air flow to radiate away from the sprayer (1). A reservoir (9) of the sprayer (1) is in fluid communication with high pressure spray nozzles (11) arranged at or near the air outlets (7). The content of the reservoir (9) is forced through the nozzles (11) under high pressure creating a fine mist in the vicinity of the air outlets (7) and in the path of the outwardly radiating air flow.

FIG. 1 furthermore shows the sprayer (1) being hitched to a tractor (20). An input shaft (17) of the sprayer (1) is connected to the power take-off (PTO) of the tractor (20) and transfers the mechanical power of from the PTO to a hydrostatic drive (13) shown schematically in the detail view at the upper right-hand side of FIG. 1.

The schematic representation of the hydrostatic drive (13) is a simplified representation that includes a hydraulic pump, hydraulic fluid reservoir, hydrostatic transmission and hydrostatic motor. The output shaft (15) of the hydrostatic drive (13) drives the fan (5) of the sprayer (1) and manipulation of the hydrostatic drive's swashplate enables the setting of the rotational speed of the fan (5) between zero, i.e. standstill, and a maximum speed. This change in speed is a virtually step-less change and substantially any speed between zero and the maximum speed may be obtained. Optionally, a further transmission may be interposed between the input shaft (17) and the hydrostatic drive (13), or between the hydrostatic drive's output shaft (15) and the fan (5), to achieve a desired maximum fan speed. The fan (5) may be connected directly to the output shaft (15) of the hydrostatic drive (13) or may be mechanically linked thereto through further mechanical linkages. The input shaft (17) may also transfer the mechanical power from the PTO to a number of other components on the sprayer (1). The fan (5) furthermore has a variable blade pitch that enables a controller of the system to control the pitch (θ) of the fan blades (6).

The applicant has empirically determined that, for the exemplary sprayer (1) shown in FIG. 1, the required air volume to be generated by the sprayer (1) for optimal (or near-optimal) application is proportional to the product of the ground speed of the sprayer, a height of the target plant which is to be sprayed, and the width of the plant to be sprayed. An application will be considered optimal if the volumetric air flow is sufficient to carry the mist created by the sprayers high enough to reach the tops of the plants and radially far enough to penetrate the entire width of the plant with minimal overshoot.

A control system (100) is provided on the sprayer (1) and is schematically represented on FIG. 1. The control system (100) is provided with components that enables it to measure a ground speed of the sprayer and a rotational speed of the fan (5). The control system (100) is further provided with components to adjust a pitch (θ) of the blades (6) of the fan (5). In the present embodiment of the control system (100) the ground speed is measured using a digital ground speed output provided by a global satellite navigation system which, in the present embodiment, is a global positioning system (GPS) module. The GPS module is in data communication with a processor of the control system (100). The control system's processor is furthermore in data communication with an RPM sensor (103) arranged to measure the rotational speed of the output shaft (15) and thus also the fan (5).

The control system (100) is in bi-directional communication with a remote server (50). The control system (100) may transmit logging data to the server (50) in real-time or may buffer the logging data and transmit it in bulk to the server. The server (50) may store the logging data in a database (52) associated with the server. Commands and configuration settings may be transmitted from the server (50) to the control system (100).

The control system (100) is arranged to measure the ground speed of the sprayer (1) and to determine whether the current rotational speed of the fan (5) is sufficient to achieve optimal application during operation of the sprayer. The derivation of the relationship between these quantities follows below.

The applicant has empirically determined that an optimal air flow rate produced by the sprayer is proportional to the product of the ground speed of the sprayer, a height of the plant to be sprayed, and the width of the plant to be sprayed. This proportionality may be expressed as the following equation:

Q_{fan}=A₁V_{sprayer}HₚₗₐₙₜWₚₗₐₙₜ Equation 1

In equation 1, Q_{fan} is the volumetric air flow produced by the fan measured in cubic meter per hour (m³/hr); A₁ is a constant; V_{sprayer} is the ground speed of the sprayer drawn by a vehicle measured in kilometre per hour (km/h); Hₚₗₐₙₜ is the height of the plant in meters (m) and Wₚₗₐₙₜ is the plant width in meters (m). The constant A₁ may depend on the architecture of a particular sprayer. For the sprayer (1) shown in FIG. 1, the applicant has found A₁ to be approximately 1000.

The applicant has also empirically determined that the volumetric air flow is proportional to the rotational speed of the fan and can be expressed as the following equation:

Q_{fan}=A₂N_{fan}+k₁ Equation 2

where A₂ is a constant multiplier; N_{fan} is the rotational speed of the fan in revolutions per minute (rpm); and k₁ is a constant offset value. The constants A₂ and k₁ may again depend on the architecture of a particular sprayer, but for the sprayer (1) shown in FIG. 1 the applicant has found Alto be approximately 19.184; and k₁ to be approximately 924.

The applicant has found that, by substituting equation 1 into equation 2, one can determine the rotational speed of the fan (N_{fan}) required for an optimal application when the ground speed (V_{sprayer}), the plant height Hₚₗₐₙₜ, and the plant width (Wₚₗₐₙₜ) are known. This may be represented by the following equation:

N_{fan(req)}=A₃V_{sprayer}HₚₗₐₙₜWₚₗₐₙₜ+k₂ Equation 3

For the sprayer (1) in shown in FIG. 1, A₃ may be determined to be approximately 52.13 and k₂ may be determined to be approximately −48.16.

Similarly, the volumetric air flow is proportional to the blade pitch angle (θ) of the fan and can be expressed as the following equation:

Q_{fan}=A₄θ+k₃ Equation 4

where A₄ is a constant multiplier; θ is the blade pitch angle of the fan; and k₃ is a constant offset value. Similarly as above, the constants A₄ and k₃ may depend on the architecture of a particular sprayer.

By substituting equation 1 into equation 4, one can determine the blade pitch angle of the fan (θ) required for an optimal application when the ground speed (V_{sprayer}), the plant height Hₚₗₐₙₜ, and the plant width (Wₚₗₐₙₜ) are known. This may be represented by the following equation:

θ_{(req)}=A₅V_{sprayer}HₚₗₐₙₜWₚₗₐₙₜ+k₄ Equation 5

It will be appreciated that, if it is desired to simultaneously adjust the rotational speed setting and the blade pitch setting, the volumetric air flow output of the fan may be expressed in an equation wherein both the rotational speed of the fan, as well as the blade pitch are independent variables as follows:

Q_{fan}=A₆N_{fan}+A₇θ+k₅ Equation 6

Furthermore, multipliers A₆ and A₇; and the constant k₅ can also be substituted to include the ground speed, plant height and plant width. The equation may be solved on the fly, or a look-up table with predetermined required volumetric air flow values against fan speed and blade pitch settings may be utilized.

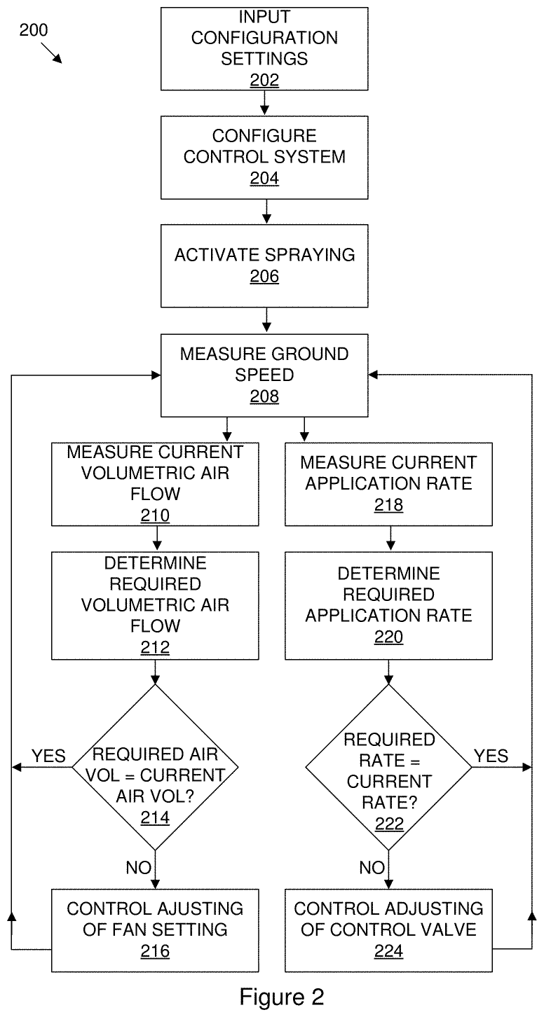

The control system (100) shown in FIG. 1 implements a method (200) in accordance with an embodiment of the invention and is illustrated by the flow diagram of FIG. 2. Before the sprayer (1) starts to administer an application of its payload to an orchard, the control system (100) is configured with configuration settings including the nominal height and width of the plants to be sprayed. The configuration settings may also include data regarding the type of agrochemical to be sprayed and the concentration thereof, for example. The control system (100) may also be configured with calibration data, such as a lookup table of volumetric air output of the fan for various rotational fan speed setting values and fan blade pitch setting values. This may be performed either locally by inputting (202) the settings on the control system (100) itself, or may be sent to the control system (100) remotely from the server (50). The control system (100) is then configured (204) with the configuration settings, including the height and width values.

When ready to start application of the agrochemical contained in the reservoir (9) of the sprayer (1), spraying is activated (206). Activation may be effected in a number of ways. For example, an activation command may be input on the control system (100) locally, optionally by the operator from the cabin of the tractor (20). The activation command may alternatively be sent remotely from the serer (50). The control system (100) may also be configured to automatically activate spraying if it detects that the sprayer (1) is moving within a certain ground speed range and/or if it detects that the sprayer has entered a configured geo-fence.

The control system (100) measures (208) a ground speed of the sprayer. In the present embodiment, the control system (100) receives digital ground speed data from a GPS module with which it is in data communication.

At a further step, the control system determines (212) a required volumetric air flow by optimization of a balance between a required air volume produced by the sprayer, an actual sprayer ground speed, and plant height and width. In one embodiment, this may be achieved in accordance with equation 3 in which the required volumetric air flow is achieved through setting the rotational fan speed by calculating the product of the configured height, the configured width, the ground speed measurement; a constant multiplier and a constant offset value. The constant multiplier and offset value may be calibrated values stored in configuration settings of the control system (100). In other embodiments this may be achieved in accordance with equation 5 in which the required volumetric air flow is achieved through setting the blade pitch of the fan. In yet further embodiments, a lookup-table as mentioned above may be used if the required volumetric air flow is to be achieved through simultaneous setting of the fan rotational speed and blade pitch.

If (214) the volumetric air flow is not equal to the determined required volumetric air flow, the control system (100) controls (216) the adjustment of a fan setting. This may include determining that the rotational speed setting of the fan requires adjustment, in which case the drive speed of the hydrostatic drive (13) is adjusted to increase or decrease its output shaft (15) rotational speed and therefore also the rotational speed of the fan (5). In the present embodiment, the drive speed is adjusted by electronically adjusting an actuator (not shown) that is mechanically linked to the swashplate of the hydrostatic drive (13). The current fan speed may be determined by using data received from an RPM sensor (103). Determining (214) whether the volumetric air flow is not equal to the determined required volumetric air flow may also, or alternatively, include determining that the current setting of the blade pitch angle (θ) is not equal to a required pitch angle setting. In the latter case, the blade pitch setting (θ) may be adjusted to obtain the required volumetric air flow.

The steps of measuring ground speed (208), determining current volumetric air flow (210), determining required volumetric air flow (212) and comparing the required volumetric air flow with the current volumetric air flow (214) are continually executed. Executing the step of controlling the adjustment of the fan setting (216) is performed only when required. This allows the control system (100) to maintain an optimal application of the sprayed agrochemical and to obtain and maintain the required rotational fan speed that optimizes a balance between a required air volume produced by the sprayer (1), an actual sprayer ground speed, and plant height and width.

In further steps, the control system (100) measures (218) a current application rate of the spray nozzles (11) of the sprayer (1). In the present embodiment, the control system (100) uses an electromagnetic flow meter (not shown) that generates a pulse after detecting that a preconfigured volume of fluid has passed there through. By measuring the time interval between pulses, the control system (100) can calculate the current application rate of the spray nozzles (11). A required application rate of the spray nozzles is determined (220) using the measured ground speed. If (222) the required application rate is not equal to the current application rate, the control system controls the adjustment of (224) a control valve (not shown) associated with the spray nozzles (11) to obtain the required application rate.

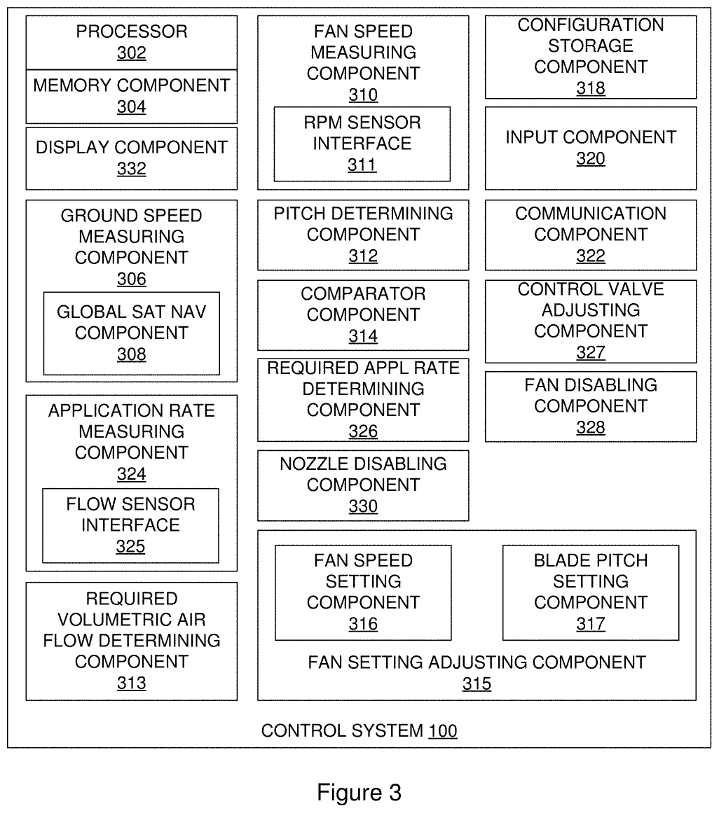

Various components may be provided for implementing the method (200) described above with reference to FIG. 2. FIG. 3 is a block diagram which illustrates exemplary components which may be provided by a control system (100) for an agricultural sprayer.

The control system (100) may include a processor (302) for executing the functions of components described below, which may be provided by hardware or by software units executing on the control system. The software units may be stored in a memory component (304) and instructions may be provided to the processor (302) to carry out the functionality of the described components. In some cases, for example in a cloud computing implementation, software units arranged to manage and/or process data on behalf of the control system may be provided remotely.

The control system (100) further includes a ground speed measuring component (306) arranged to measure a ground speed of the sprayer (1). The ground speed measuring component (306) produces a digital data representation of the measured ground speed and communicates it to the processor (302) for use in subsequent computations. The ground speed measuring component (306) includes a global satellite navigation component (308) that is arranged to obtain ground speed measurements from a GPS module that is internal to the control system (100). However, it is envisaged that the global satellite navigation component (308) may alternatively include a GPS interface for connecting the global satellite navigation component to an external GPS module.

The control system (100) also includes a fan speed measuring component (310) that is arranged to measure a current rotational speed of a fan (5) of the sprayer (1) by measuring the rotational speed of the shaft to which the fan is connected. In the present embodiment, this is the output shaft (15) of the hydrostatic drive (13). The fan speed measuring component (310) includes an RPM sensor interface (311) for interfacing the control system (100) with an RPM sensor (103), which generates a pulse on every revolution of the shaft (15) and counts the number of pulses generated within a sample time period. This allows the fan speed measuring component (310) to determine a digital data representation of the fan's rotational speed measured in revolutions per minute (rpm). The RPM sensor (103) may include a Hall Effect sensor that generates a pulse when a magnet that is mounted on the shaft (15) passes it on every revolution. However, optical methods known in the art may also be utilized.

The control system (100) further includes a pitch determining component (312) for determining a current blade pitch angle (θ) setting.

A required volumetric air flow determining component (313) of the control system (100) is arranged to determine a required volumetric air flow of the fan (5) using the measurements of the ground speed measuring component, and a configured plant height and width. It further makes use of air volume delivery curves at different rotational fan speeds and a calibrated multiplication constant stored in configuration settings of the control system (100) to determine the required volumetric air flow.

The control system (100) further includes a comparator component (314) that is arranged to compare the current and required volumetric air flows of the fan. If the current and required volumetric air flows are equal, or differs within an allowable tolerance, the comparator component (314) will take no action. If the comparator component (314) finds that the current and required volumetric air flows differ, it will indicate to a fan setting adjustment component (315) that it should adjust one or more fan settings. For example, if the current volumetric flow is greater than required, it will indicate to the fan setting adjusting component (315) that a reduction in fan speed is required. Conversely, if the comparator component (314) finds that the current volumetric flow is lower than required, it will indicate to the fan setting adjusting component (315) that an increase in fan speed is required. The fan setting adjusting component may (315) therefore include a fan speed setting component (316) for adjusting the fan speed setting as may be required. It also includes a blade pitch setting component (317) to enable it to set the blade pitch angle (θ) as may be required.

The fan speed adjusting component (316) is adapted to control the adjusting of a drive speed of a drive associated with the fan which, in the present embodiment, is the hydrostatic drive (13). The drive speed adjusting component (316) is linked to an actuator that is operable to manipulate the swashplate of the hydrostatic drive (13), thereby adjusting the rotational speed of the output shaft (15). This therefore adjusts the speed of the fan (5) since it is connected to the output shaft (15).

The control system (100) includes a configuration storage component (318) for storing configuration and calibration settings. The configuration settings include the configured height and width of the plants to which the sprayer administers its payload. The configuration settings may further include calibration settings, such as the constants described with reference to equations 1 to 3 above.

Configuration settings may be inputted into the control system by means of an input component (320), either locally from a user or remotely from a remote server (50). The control system (100) further includes a communication component (322) adapted to enable bi-directional communication between the control system and the remote server (50).

An application rate measuring component (324) is provided that is adapted to measure a current application rate of spray nozzles (11) of the sprayer (1). The application rate measuring component (324) includes a flow sensor interface (325) for interfacing the control system (100) with a flow sensor (not shown), which generates a pulse when a configured volume of the sprayer's payload has passed in a conduit that feeds the nozzles (11) with the contents of the reservoir (9). The application rate measuring component (324) counts the number of pulses generated within a sample time period which enables it to determine a digital data representation of the current application rate of the sprayer payload stored in the reservoir (9) measured in cubic meters per hour (m³/h).

A required application rate determining component (326) is provided for determining a required application rate of the spray nozzles (11) using the measured ground speed. The comparator component (314) is further configured to compare the current application rate with the required application rate. If these quantities are equal or differs within an allowable tolerance it will take no action. If the current application rate is greater than the required application rate, the comparator component (314) will signal a control valve adjusting component (327) to control the adjustment of a control valve (not shown) associated with the spray nozzles (11) to decrease the flow rate. Conversely, it will signal the control valve adjusting component (327) to increase the application rate if the current application rate is lower than the required application rate.

A fan disabling component (328) is provided for disabling the fan (5) if the ground speed measured by the ground speed measuring component (306) is below a minimum ground speed threshold stored in the configuration storage component (318). The fan disabling component (328) may disable the fan by instructing the drive speed adjusting component (316) to set the swashplate of the hydrostatic drive (13) to a neutral position by means of its actuator. The control system (100) also includes a nozzle disabling component (330) adapted to disable the spray nozzles (11) if the measured ground speed is below the minimum ground speed threshold stored in the configuration storage component (318).

The control system may further include a display component (332) adapted to display status information to a user by means of one or more displays and indicator lights.

Although the control system (100) has been schematically represented as a single unit, it should be understood that the control system may comprise a number of discrete units that, when interconnected, form the control system. Each discrete unit may include one or more of the functional components described with reference to FIG. 3 and some of the functional modules may be duplicated by the discrete units if required. The discrete units may be positioned on various locations about the sprayer (1) and may even extend to the vehicle drawing the sprayer, i.e. the tractor (20). The discrete units may be in data communication with each other through cables or by means of wireless communication.

For example, in one embodiment some of the functional components such as the application rate measuring component (324), required application rate determining component (326), control valve adjusting component (327) and nozzle disabling component (330) may be provided by a spray controller that is housed physically separate from the rest of the control system (100). Such a spray controller would, however, be functionally integrated with the other functional components to form the control system (100). The duplication of functional components such as the processor (302) and memory component (304), for example, may then be required by such a spray controller.

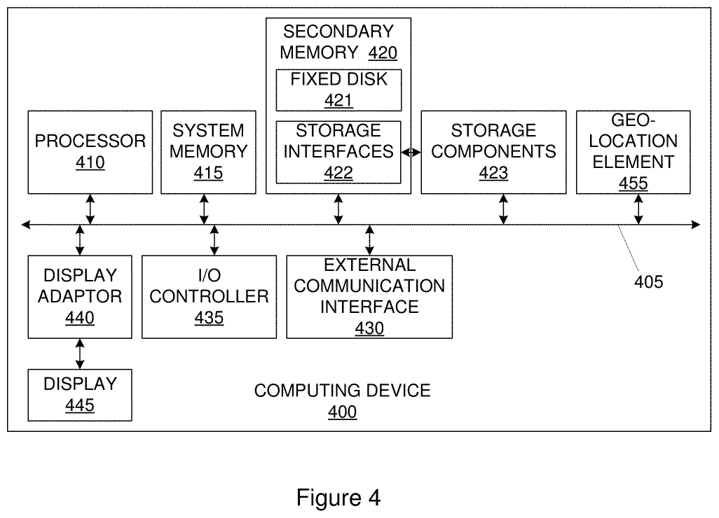

FIG. 4 illustrates an example of a computing device (400) in which various aspects of the disclosure may be implemented. The computing device (400) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (400) may be suitable for storing and executing computer program code. The various participants and elements in the previously described system diagrams may use any suitable number of subsystems or components of the computing device (400) to facilitate the functions described herein. The computing device (400) may include subsystems or components interconnected via a communication infrastructure (405) (for example, a communications bus, a network, etc.). The computing device (400) may include one or more processors (410) and at least one memory component in the form of computer-readable media. The one or more processors (410) may include one or more of: CPUs, graphical processing units (CPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (400) may be distributed over a number of physical locations (e.g. in a distributed, cluster or cloud-based computing configuration) and appropriate software units may be arranged to manage and/or process data on behalf of remote devices.

The memory components may include system memory (415), which may include read only memory (ROM) and random access memory (RAM). A basic input/output system (BIOS) may be stored in ROM. System software may be stored in the system memory (415) including operating system software. The memory components may also include secondary memory (420). The secondary memory (420) may include a fixed disk (421), such as a hard disk drive, and, optionally, one or more storage interfaces (422) for interfacing with storage components (423), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (400) may include an external communications interface (430) for operation of the computing device (400) in a networked environment enabling transfer of data between multiple computing devices (400) and/or the Internet. Data transferred via the external communications interface (430) may be in the form of signals, which may be electronic, electromagnetic, optical, radio, or other types of signal. The external communications interface (430) may enable communication of data between the computing device (400) and other computing devices including servers and external storage facilities. Web services may be accessible by and/or from the computing device (400) via the communications interface (430).

The external communications interface (430) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (410). A computer program product may be provided by a non-transient computer-readable medium, or may be provided via a signal or other transient means via the communications interface (430).

Interconnection via the communication infrastructure (405) allows the one or more processors (410) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (400) either directly or via an I/O controller (435). One or more displays (445) (which may be touch-sensitive displays) may be coupled to or integrally formed with the computing device (400) via a display (445) or video adapter (440).

The computing device (400) may include a geographical location element (455) which is arranged to determine the geographical location of the computing device (400). The geographical location element (455) may for example be implemented by way of a global positioning system (GPS), Global Navigation Satellite System (GLONASS) or similar, receiver module. In some implementations the geographical location element (455) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (400). In some implementations, the geographical location element (455) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™ C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

What is claimed is:

1. A computer-implemented method for administering agrochemicals with an agricultural sprayer, the method performed at a control system of the sprayer and comprising:
measuring a ground speed of the sprayer;
obtaining a current volumetric air flow produced by a fan of the sprayer;
determining a required volumetric air flow of the fan using the measured ground speed, a configured plant height and width and using sprayer air volume delivery curves at different fan settings; and
controlling the adjustment of a setting of the fan to obtain the required volumetric air flow if different from the current volumetric air flow.

2. A method as claimed in claim 1 wherein controlling the adjustment of a setting of the fan to obtain the required volumetric air flow includes the optimization of a balance between a required volumetric air flow produced by the sprayer, an actual sprayer ground speed, and plant height and width.

3. A method as claimed in claim 1 further including measuring a current application rate of spray nozzles of the sprayer; determining a required application rate of the spray nozzles using the measured ground speed; and controlling the adjustment of a control valve associated with the spray nozzles to obtain the required application rate if different from the current rate.

4. A method as claimed in claim 1 wherein measuring the ground speed includes one or a combination of: obtaining ground speed data from a global satellite navigation system in communication with the control system; obtaining ground speed data by means of a Doppler-effect ground speed sensor; and measuring a number of revolutions of a wheel of the sprayer over a time period and obtaining the ground speed by using this measurement and a configured circumference of the wheel.

5. A method as claimed in claim 1 further including disabling the fan if the measured ground speed is below a minimum ground speed threshold.

6. A method as claimed in claim 1 further including disabling the spray nozzles if the measured ground speed is below a minimum ground speed threshold.

7. A method as claimed in claim 1 wherein controlling the adjustment of the fan setting includes controlling the adjustment of a pitch of the fan blades.

8. A method as claimed in claim 1 wherein the step of controlling the adjustment of the setting includes controlling the adjustment of a drive speed of a drive associated with the fan.

9. A method as claimed in claim 8 wherein the step of controlling the adjustment of the drive speed includes adjusting a gear ratio of the drive to obtain a required rotational fan speed.

10. A method as claimed in claim 9 wherein the variable gear ratio transmission is selected from the group consisting of: a hydrostatic drive and the step of adjusting the gear ratio includes adjusting a swashplate of the hydrostatic drive; or a continuously variable transmission (CVT) and the step of adjusting the gear ratio includes adjusting a ratio of the CVT.

11. A method as claimed in claim 8 wherein the drive associated with the fan is selected form the group consisting of: an internal combustion engine with an electronically controllable throttle and adjustment of the drive speed includes adjusting the throttle; or an electric motor controlled with a variable speed drive and adjustment of the drive speed includes adjusting the variable speed drive.

12. A method as claimed in claim 1 wherein the sprayer is powered by a power take-off (PTO).

13. A method as claimed in claim 1 wherein the sprayer is adapted to be drawn by a tractor.

14. A control system for an agricultural sprayer comprising:
a ground speed measuring component arranged to measure a ground speed of the sprayer;
a volumetric air flow obtaining component arranged to obtain a current volumetric air flow of a fan of the sprayer;
a configuration storage component arranged to store a configured plant height and width;
a required volumetric air flow obtaining component arranged to obtain a required volumetric air flow of the fan using measurements of the ground speed measuring component, the configured plant height and width, and air volume delivery curves at different fan settings; and
a fan setting adjusting component arranged to control the adjustment of a setting of the fan to obtain the required volumetric air flow if different from the current volumetric air flow.

15. A control system as claimed in claim 14 further including an application rate measuring component for measuring a current application rate of spray nozzles of the sprayer; a required application rate determining component for determining a required application rate of the spray nozzles using the measured ground speed; and a control valve adjusting component for controlling the adjustment of a control valve associated with the spray nozzles to obtain the required application rate if different from the current rate.

16. A control system as claimed in claim 15 wherein the application rate measuring component is in communication with a flow sensor adapted to detect the flow rate of a fluid in a conduit that feeds the nozzles.

17. A control system as claimed in claim 14 wherein the fan setting adjusting component is adapted to disable the fan if the measured ground speed is below a minimum ground speed threshold stored in the configuration storage component.

18. A control system as claimed in claim 15 wherein the control valve adjusting component is adapted to disable the spray nozzles if the measured ground speed is below a minimum ground speed threshold stored in the configuration storage component.

19. A control system as claimed in claim 14 wherein the fan setting adjusting component includes a blade pitch setting component arranged to control the adjustment of a blade pitch setting of the fan

20. A control system as claimed in claim 14 wherein the fan setting adjusting component includes a fan speed setting component arranged to control a speed setting of a drive associated with the fan to thereby control a rotational speed setting of the fan.
